(19) United States
(12) Patent Application Publication
(10) Pub. No.: US 2009/0228210 A1
(43) Pub. Date: Sep. 10, 2009

(54) NAVIGATION SYSTEM BASED ON NEUTRINO DETECTION

(75) Inventor: Gregory M. GUTT, Ashburn, VA (US)

Correspondence Address: SAWYER LAW GROUP, LLP, 2465 E. Bayshore Road, Suite No. 406, PALO ALTO, CA, 94303, US

(73) Assignee: THE BOEING COMPANY, Chicago, IL (US)

(21) Appl. No.: 11/770,652

(22) Filed: Jun. 28, 2007

(51) Int. Cl. G01C 21/16

(52) U.S. Cl. 701/220; 701/207

(57) ABSTRACT

A method and system for navigating is disclosed. The method and system comprises measuring the angle of arrival of neutrinos emitted by a source and tagging the neutrino measurements utilizing an accurate clock. The method and system further includes processing the tagged neutrino measurements through a computational model of a neutrino generator and combining the processed measurements with navigational aids to provide location information. A system and method in accordance with an embodiment measures angle of arrival of neutrinos generated by the sun, and therefore derives navigation information which is obtainable deep underground or underwater. Additionally, the system provides robust navigation, without drift, in the absence of other common navigation systems such as global positioning systems.

### FIELD OF THE INVENTION

The present embodiment relates generally to navigation systems and more particularly to a navigation based on neutrino detection.

### BACKGROUND OF THE INVENTION

Navigation systems are utilized with a variety of entities such as for aircraft, boats and submarines. Typically, an inertial navigation system is utilized with a plurality of sensors to provide location information of an entity.

A typical inertial navigation system integrates the information gathered from a combination of gyroscopes and accelerometers in order to determine the current state of the system. Gyroscopes measure the angular velocity of the system in the inertial reference frame. By using the original orientation of the system in the inertial reference frame as the initial condition and integrating the angular velocity, the system's current orientation is known at all times. Accelerometers measure the linear acceleration of the system in the inertial reference frame, but in directions that can only be measured relative to the moving system (since the accelerometers are fixed to the system and rotate with the system, but are not aware of their orientation).

However, by tracking both the current angular velocity of the system and the current linear acceleration of the system measured relative to the moving system, it is possible to determine the linear acceleration of the system in the inertial reference frame. Performing integration on the inertial accelerations (using the original velocity as the initial conditions) using the correct kinematic equations yields the inertial position.

All inertial navigation systems suffer from integration drift. Small errors in the measurement of acceleration and angular velocity are integrated into progressively larger errors in velocity, which is compounded into errors in position. This is a problem that is inherent in every open loop control system.

Inertial navigation may also be used to supplement other navigation systems, providing a higher degree of accuracy than is possible with the use of any single navigation system. For example, if, in terrestrial use, the inertially tracked velocity is intermittently updated to zero by stopping, the position will remain precise for a much longer time, a so-called zero velocity update.

Control theory in general and filtering in particular provide a theoretical framework for combining information from various sensors. One of the most common alternative sensors is a satellite navigation radio such as a Global Positioning System (GPS). By properly combining the information from an INS and the GPS system, the errors in position and velocity are stable.

However, there are some environments where it becomes difficult to address integration drift. For example, on a submarine, it is important to remain underwater a significant amount of time due to military considerations and it may be undesirable to resurface within a specified time period. Modern navigation systems require GPS for sustained operations. Accordingly, prolonged GPS outages can severely degrade navigation performance. GPS reception under 100 feet of water becomes difficult if not impossible because water attenuates the L-bond GPS signal. Therefore submarines are particularly susceptible to GPS outages during protracted undersea operations. In another example, the vehicle may be underground for an extended period of time where the conventional sensors such as GPS, altimeters, beams and the like may not be used.

What is needed is a method and system to provide an effective navigation system particularly when a body is underground or under water. The present embodiment addresses such a need.

### SUMMARY OF THE INVENTION

A method and system for navigating is disclosed. The method and system comprises measuring the angle of arrival of neutrinos emitted by a source and tagging the neutrino measurements utilizing an accurate clock. The method and system further includes processing the tagged neutrino measurements through a computational model of a neutrino generator and combining the processed measurements with navigational aids to provide location information.

A system and method in accordance with an embodiment measures angle of arrival of neutrinos generated by the sun, and therefore derives navigation information which is obtainable deep underground or underwater. Additionally, the system provides robust navigation, without drift, in the absence of other common navigation systems such as global positioning systems.

The features, functions, and advantages can be achieved independently in various embodiments of the present inventions or may be combined in yet other embodiments.

### BRIEF DESCRIPTION OF THE DRAWINGS

FIG. 1 illustrates a block diagram of the elements for a navigation system 100 in accordance with the present embodiment.

FIG. 2 is a flow chart of a process for navigation with the present embodiment.

### DETAILED DESCRIPTION

The following description is presented to enable one of ordinary skill in the art to make and use the embodiment and is provided in the context of a patent application and its requirements. Various modifications to the embodiments and the generic principles and features described herein will be readily apparent to those skilled in the art. Thus, the present embodiment is not intended to be limited to the embodiments shown, but is to be accorded the widest scope consistent with the principles and features described herein.

At any given location on the surface of the earth there is a unique angular relationship to the sun which is well understood and can be captured within an accurate sun-earth model. If one provides time into the model, and angle of arrival information (as measured by a user on the earth) there is a unique position associated with those measurements. The only other information required is the notion of down (which can be extracted from gravity). Heading then can be derived by making several observations over time.

It is known that the sun generates atomic particles known as neutrinos which only weakly interact with matter. Neutrinos are able to penetrate the earth completely with negligible interference. Methods disclosed for neutrino detection systems are described, for example, in “Underwater Acoustic Detection of Ultra High Neutrinos,” V. Niess and V. Bertin; “Observation of high-energy neutrinos using Cerenkov detectors embedded deep in Antartic ice,” E. Andres, et al., Nature, vol. 410, Mar. 22, 2001; “Review of Solar Neutrino Experiments,” A. Bellerive, arxiv:hep-ex/0312045, v. 1, Dec. 16, 2003; and “On-line monitoring of underwater acoustic background at 2000 m depth,” G. Riccobene, et al., 29^{th} International Cosmic Ray Conference Pune (2005) 00, 101-106.

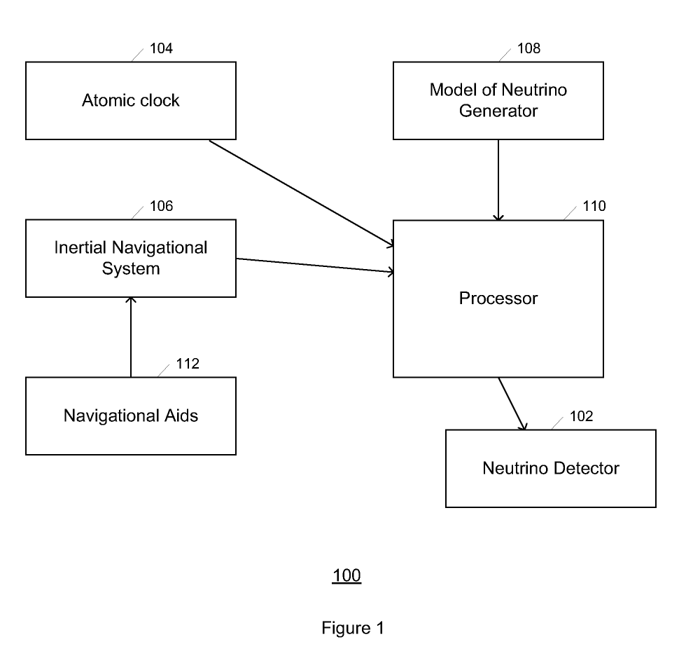

FIG. 1 illustrates a block diagram of the elements for a navigation system 100 in accordance with the present embodiment. The navigation system 100 comprises an accurate clock, for example, an atomic clock 104, an inertial navigational system 106, navigational aids 112, a computational model of a neutrino generator 108, a processor 110 and a neutrino detector 102.

Accordingly, neutrino radiation could be detected utilizing neutrino detector 102. Neutrino detection may be accomplished, for example, by hydrophone sensors as described in the above-identified disclosures. The neutrino detector 102 is then tagged with time information with an accurate clock such as atomic clock 104. The tagged neutrino measurements are processed by the processor 110 utilizing the computational model of a neutrino generator 108. The signals from a precise inertial navigation system and from the navigational aids are then combined with information from system 106 utilizing processor 110. Navigational aids include but are not limited to a depth gauge, an altimeter, a compass, a vision system and a sonar system.

Therefore, the combined system produces suitable accuracy for a system such as an underwater or underground vehicle, indefinitely without the use of GPS or other means. This can contribute to the stealth of missions and of course supplement operations if GPS is non-operational. To describe a method of navigation utilizing the system 100 in accordance with the present embodiment in more detail, refer now to the following description in conjunction with the accompanying figures.

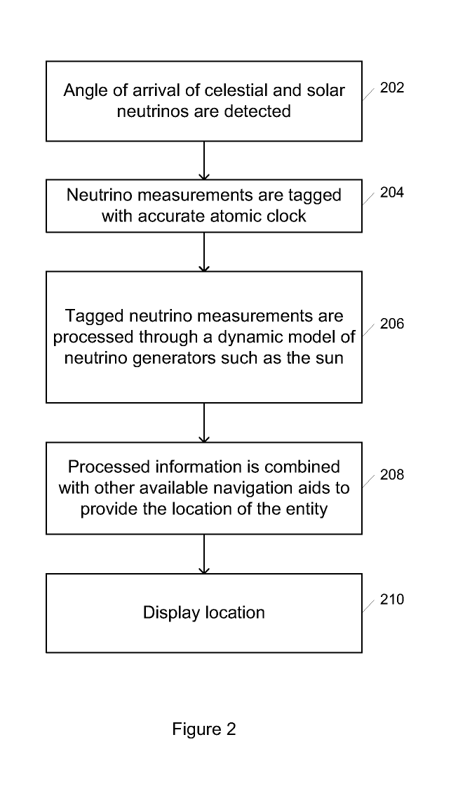

FIG. 2 is a flow chart of a process for navigation with the present embodiment. First, the angle of arrival of celestial and solar neutrinos are detected, via step 202. Measurements can be taken in simultaneously over a given geometry to add additional information. For example, angle of arrival of solar neutrinos taken simultaneously separated by a few inches can also produce heading information. Measurements can also be taken continuously over time so that coherent integration techniques can be applied synchronous with earth's rotation.

Next, the neutrino measurements are tagged with an accurate clock, via step 204. The accurate clock could be, for example, the atomic clock 104.

Next, the neutrino angle of arrival and clock information are processed through a computational model of a neutrino generator, via step 206. For example, the neutrino generator could be celestial generators such as the sun. Furthermore, neutrinos from other celestial bodies such as distant stars could be utilized for the computational model. In another example, a device that emits neutrinos such as a nuclear submarine could be located via this process. The model should account for rotation and other known dynamic effects such as general and special relativity, etc.

The processed information is then combined with other available navigational aids to provide the location of the entity, via step 208. The navigational aids include but are not limited to inertial navigation, altimeter, depth gauge, radar, vision, and radio navigation systems. In one example the integration of this information is processed utilizing a Kalman filter. In one embodiment, the outputs such as latitude, longitude, altitude and estimate of navigation efforts and biases in the system are filtered to further refine the location.

The navigation information is then displayed for the user and/or communicated to other systems as required, via step 210.

Accordingly, a method and system in accordance with the present embodiment could also be utilized in a variety of ways. Celestial neutrinos could be detected to provide the location of an entity such as a submarine or an underground vehicle. This system could also be utilized to detect enemy underwater vehicles such as nuclear submarines. The nuclear reactor on the submarine generates neutrinos, thereby enabling detection by utilizing the method and system described in the present embodiment.

Although the present embodiment has been described in accordance with the embodiments shown, one of ordinary skill in the art will readily recognize that there could be variations to the embodiments and those variations would be within the spirit and scope of the present embodiment. Accordingly, many modifications may be made by one of ordinary skill in the art without departing from the spirit and scope of the appended claims.

What is claimed is:

1. A method for navigating comprising:
measuring the angle of arrival of neutrinos emitted by a source;
tagging the neutrino measurements utilizing an accurate clock;
processing the tagged neutrino measurements through a computational model of a neutrino generator; and
combining the processed measurements with navigational aids to provide location information.

2. The method of claim 1 wherein the neutrinos are emitted from a celestial source.

3. The method of claim 2 wherein the celestial source comprises the sun.

4. The method of claim 1 wherein the neutrinos are emitted from a submarine.

5. The method of claim 1 wherein the navigational aids comprise an inertial navigation system.

6. The method of claim 5 wherein the navigational aids include any or any combination of a depth gauge, compass system and sonar systems.

7. The method of claim 1 wherein the angle of arrival measurement is provided utilizing hydrophone sensors.

8. The method of claim 1 wherein the computational model comprises an earth-sun computational model.

9. The method of claim 1 which includes displaying the location information.

10. The method of claim 9 wherein the location comprises the location of a system being navigated.

11. The method of claim 9 wherein the location information comprises the location of a system being tracked.

12. A computer readable medium containing program instructions, the program instructions for:
measuring the angle of arrival of neutrinos emitted by a source;
tagging the neutrino measurements utilizing an accurate clock;
processing the tagged neutrino measurements through a computational model of a neutrino generator; and
combining the processed measurements with navigational aids to provide location information.

13. The computer readable medium of claim 12 wherein the neutrinos are emitted from a celestial source.

14. The computer readable medium of claim 12 wherein the celestial source comprises the sun.

15. The computer readable medium of claim 12 wherein the neutrinos are emitted from a submarine.

16. The computer readable medium of claim 12 wherein the navigational aids comprise an inertial navigation system.

17. The computer readable medium of claim 16 wherein the navigational aids include any or any combination of a depth gauge, compass system and sonar systems.

18. The computer readable medium of claim 12 wherein the angle of arrival measurement is provided utilizing hydrophone sensors.

19. The computer readable medium of claim 12 wherein the computational model comprises an earth-sun computational model.

20. The computer readable medium of claim 12 which includes displaying the location information.

21. The computer readable medium of claim 20 wherein the location comprises the location of a system being navigated.

22. The computer readable medium of claim 20 wherein the location information comprises the location of a system being tracked.

23. A system comprising:
a neutrino detection system able to detect angle of arrival information from neutrinos;
a computational model of neutrino generation; and
an inertial navigation system, wherein the neutrino detection system, computation model and inertial navigation system combine to provide location information of an entity.

24. The system of claim 23 wherein the neutrinos are emitted from a celestial source.

25. The system of claim 23 wherein the celestial source comprises the sun.

26. The system of claim 23 wherein the neutrinos are emitted from a submarine.

27. The system of claim 23 wherein the navigational aids comprise an inertial navigation system.

28. The system of claim 27 wherein the navigational aids include any or any combination of a depth gauge, compass system and sonar systems.

29. The system of claim 23 wherein the angle of arrival measurement is provided utilizing hydrophone sensors.

30. The system of claim 23 wherein the computational model comprises an earth-sun computational model.

31. The system of claim 23 which includes displaying the location information.

32. The system of claim 31 wherein the location comprises the location of a system being navigated.

33. The system of claim 31 wherein the location information comprises the location of a system being tracked.

34. The system of claim 32 wherein neutrinos emitted by a nuclear submarine are detected to locate the nuclear submarine.
